(19) United States
(12) Patent Application Publication
(10) Pub. No.: US 2022/0402155 A1
(43) Pub. Date: Dec. 22, 2022

(54) SHEAR RAZOR DEVICE

(71) Applicants: Mylenya Crawford, Westampton, NJ (US); Patrick Crawford, Westampton, NJ (US)

(72) Inventors: Mylenya Crawford, Westampton, NJ (US); Patrick Crawford, Westampton, NJ (US)

(21) Appl. No.: 17/842,502

(22) Filed: Jun. 16, 2022

Related U.S. Application Data
(60) Provisional application No. 63/211,523, filed on Jun. 16, 2021.

(51) Int. Cl. B26B 21/40; B26B 21/10; B26B 21/52

(52) U.S. Cl. CPC B26B 21/4012; B26B 21/10; B26B 21/52

(57) ABSTRACT

Shear razor devices for cutting and styling hair with a shear razor device using a hair shear functionality, a razor functionality, or both. The shear razor device includes a thumb member having a grip portion and a blade portion, and a finger member having a grip portion and a blade portion. The thumb member and the finger member are pivotally attached to each other for the hair shear functionality. The blade portion of the finger member may be comprised of a flat inner wall joined with a tapered outer wall at lower portions thereof to form an inner blade of the finger member as part of the hair shear functionality. The flat inner wall and the tapered outer wall may be disjoined at upper portions thereof to form an elongated groove configured to removably accept and secure a razor therein for the razor functionality.

### RELATED APPLICATIONS

Under provisions of 35 U.S.C. § 119(e), the Applicant claims the benefit of U.S. provisional application no. 63/211,253, filed Jun. 16, 2021, which is incorporated herein by reference.

### FIELD

The disclosure relates to improved shear razor devices for cosmetic and hygienic applications. A shear razor device includes a thumb member pivotally attached to a finger member, and each of the thumb member and the finger member includes an inner blade to enable the shear razor device to function as hair shears or scissors. A blade portion of the finger member may be comprised of a flat inner wall joined with a tapered outer wall at lower portions thereof to form the inner blade of the finger member. The flat inner wall and the tapered outer wall may be disjoined at upper portions thereof to form an elongated groove configured to removably accept and secure a razor therein. The shear razor device enables individuals to efficiently cut and style hair with the hair shear functionality, the razor functionality, or both.

It is intended that each of the referenced applications may be applicable to the concepts and embodiments disclosed herein, even if such concepts and embodiments are disclosed in the referenced applications with different limitations and configurations and described using different examples and terminology.

### BACKGROUND

Many individuals, such as barbers and hair stylists, use hair shears for reducing overall hair length, and use a straight razor for thinning hair to provide a particular appearance or style. These individuals may need to frequently switch between the hair shears and the straight razor for performing these and other styling techniques, which is time-consuming and may detract from the customer experience. In addition, because the hair shear functionality and the razor functionality are embodied in different devices, this may cause additional issues, such as loss or misplacement of either or both devices, which can cause further delays.

Accordingly, there is a need for a shear razor device that incorporates both the hair shear functionality and the razor functionality into a single, unified device. The present invention addresses this unmet need.

### SUMMARY

In one aspect, the invention provides a shear razor device, comprising: a thumb member, the thumb member comprising a grip portion affixed to a blade portion, a finger member, the finger member comprising a grip portion affixed to a blade portion, wherein the thumb member and the finger member are pivotally attached to each other for a hair shear functionality of the shear razor device, wherein the blade portion of the finger member comprises an elongated groove configured to removably accept and secure a razor therein for a razor functionality of the shear razor device.

The grip portion of the finger member may comprise a finger ring with a finger rest affixed thereto, configured to improve an individual's grasp of the shear razor device during use. The razor may be removably insertable into a razor cartridge, wherein the razor cartridge is removably insertable into the elongated groove to removably secure the razor in the elongated groove for the razor functionality. The razor cartridge may enable any of a variety of different razors to be used with the shear razor device and may improve a friction fit between the elongated groove and the razor.

The blade portion of the thumb member may terminate at a distal point, and the blade portion of the finger member may terminate at a distal razor cartridge insertion, wherein the distal razor cartridge insertion is substantially flat. The razor may be removably insertable into a razor cartridge, wherein the razor cartridge is removably insertable into the elongated groove via the distal razor cartridge insertion to removably secure the razor in the elongated groove for the razor functionality. Insertion in this or similar manners may reduce a risk of injury to the individual compared to different manners of inserting the razor into the elongated groove.

The shear razor device may be configured for a left-handed use, a right-handed use, or both, and such configurations may involve a different structure or configuration of the finger member relative to the thumb member. The elongated groove may be comprised of a wider base and a narrower opening, wherein at least the narrower opening removably accepts and secures the razor therein via a friction fit. The friction fit may be improved with use of the razor cartridge.

Because any of a plurality of additional functionalities may be provided by different devices and structures used by barbers and hair stylists, at least one such additional functionality may, in certain implementations of the shear razor device, not be desired for a particular use or combination of uses. Accordingly, in implementations, the shear razor device may not comprise an additional structure that is related to an additional functionality. In certain instances, the additional structure may comprise a comb and the additional functionality may comprise combing hair. In this manner, the structure and function of the shear razor device may relate primarily, or exclusively, to cutting or trimming hair, e.g., length-trimming, thinning, or both.

The razor may comprise a straight razor with at least one edge thereon. Any suitable straight razor may be used, including disposable or single-use straight razors as well as at least one straight razor that may be sharpened and re-used. In certain implementations, the straight razor may be advantageous for thinning hair. During a use of the hair shear functionality, the thumb member may be moved in a scissoring motion relative to the finger member, and during such use, the finger member may be substantially stationary relative to a bundle of hair cut by the hair shear functionality.

In implementations, the elongated groove may be positioned along an upper portion of the blade portion of the finger member, wherein a lower portion of the blade portion of the finger member comprises an inner blade that functions as part of the hair shear functionality. The blade portion of the finger member may be comprised of a flat inner wall joined with a tapered outer wall at lower portions thereof to form the inner blade. The flat inner wall and the tapered outer wall may be disjoined at upper portions thereof to form the elongated groove. Accordingly, in implementations, the blade portion of the finger member may comprise the inner blade on the lower portion formed by the flat inner wall and the tapered outer wall.

The invention generally relates to improved shear razor devices which may be manufactured with appropriate materials and processes and which may be scaled as needed.

Other objects, features, and advantages of the invention will become apparent from the following detailed description taken in conjunction with the accompanying drawings.

### BRIEF DESCRIPTION OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIGS. 1A, 1B, 1C, 1D, 1E, 1F, 1G, 1H, 11, 1J, and 1K depict several views of a first exemplary shear razor device.

FIGS. 2A, and 2B depict several views of the first exemplary shear razor device being held by an individual.

FIGS. 3A and 3B depict additional views of exemplary embodiments of shear razor devices and accessories thereof.

### DETAILED DESCRIPTION

Reference is made herein to the attached drawings. Like reference numerals may be used in the drawings to indicate like or similar elements of the description. The figures are intended for representative purposes and should not be considered limiting.

In certain instances, the shear razor device 100 may further comprise a point, blade, wing, joint, adjustment screw, shank, finger flat, finger bows, outside ring, inside ring, bumper, finger rest, and the likeness thereof. In one or more instances, the shear razor device 100 may be described using at least one of the following hair scissors parts and descriptors including but not limited to: The ends of the blades may be called the points or tips; The handles may be called finger bows. The term finger bows may be used to describe where a user inserts his or her fingers. There may be at least two types of finger bows— one for the thumb, and one for the other fingers like the forefinger and middle finger; The blades have different parts, including the outside part which may be called the backside or the dull edge of the blade; the sharp part of the blade may be called the edge. The thumb blade is the blade connected to the finger bow for the thumb, while the finger blade is the one that's linked to the finger bow for the other fingers.

Regarding the edge, it may be configured in different types, too; an adjustment screw may connect both the handles and blades right in the middle. Adjustment screws may be configured to be adjustable and non-adjustable. As the term suggests, an adjustable adjustment screw may allow a user to alter the tension of cutting. A non-adjustable screw, on the other hand, may merely connect the handles and blades. Meanwhile, the screw hole may be the part where the screw attaches to the blades; a bumper or stopper may be a cushion placed right between the finger bows; a finger rest, meanwhile, may be a piece of metal that serves as finger support. It may be configured to alleviate stress on the wrist and shoulders. It can also be configured to be removable or non-removable; A shank may connect the finger bows to the blades. Meanwhile, the wing may be the part of the scissor sandwiched between the shank and the adjustment screw.

The outer part of the finger bow may be called the outside ring, while the inner part may be called the inside ring; the surface of the finger bow may be called the ring flat; the part where both the blades meet is called the joint. Regarding size, this may pertain to the total length of any scissors. It is measured from the points to the edge of the finger bows. The size of scissors varies in terms of the unit of measurements, and this can be determined by the country from which the scissors are made. Regarding the edges, for example, scissors with serrated edge blades may be ideal for beginners because the edges tend to slip less. This may be configured to provide a user (i.e., in this case, a barber or hairdresser) more control in cutting dry hair.

In one or more instances, shear razor device 100 may comprise scissors with straight edge blades configured to be best used in employing certain hair cutting techniques like point cutting and slice cutting. In one or more embodiments, shear razor device 100 may comprise scissors with convex edge blades known for their sharpness and thus, best suited for smooth cutting and thinning hair. In one or more embodiments, the shear razor device may be configured for use or reserved for use by professional hairdressers. In one or more instances, shear razor device 100 may have a logo that indicates the name of the shear manufacturer, the model number, steel used, and size.

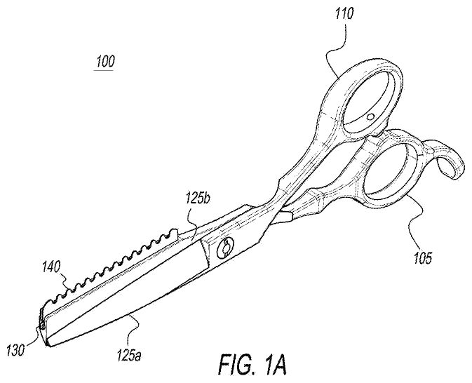

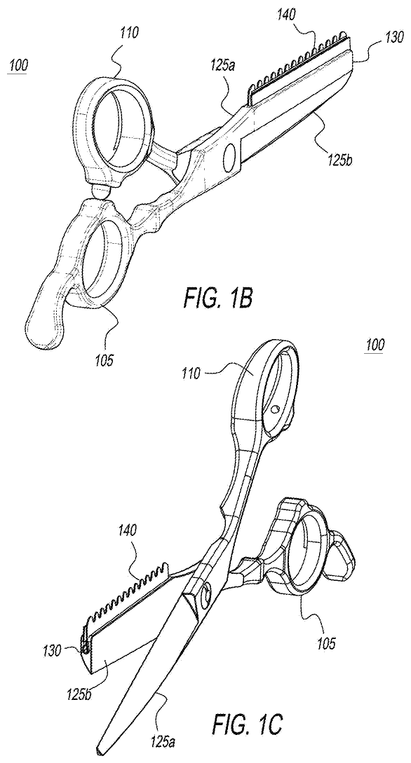

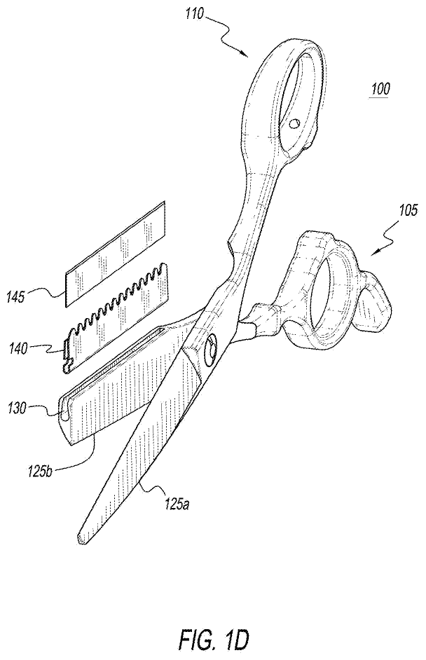

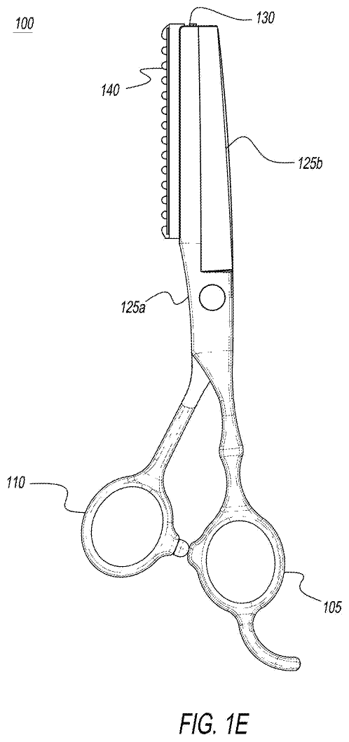

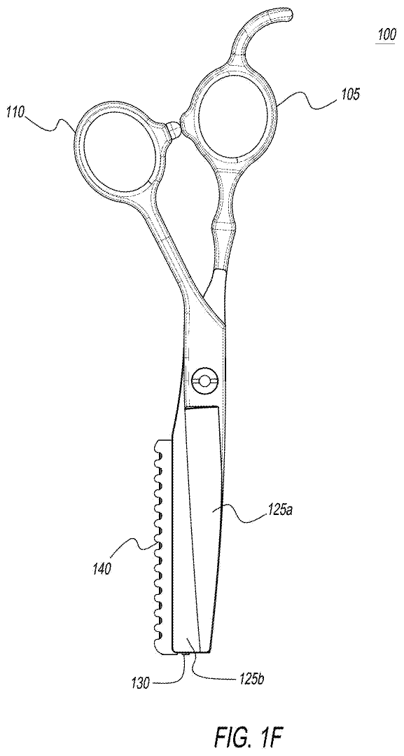

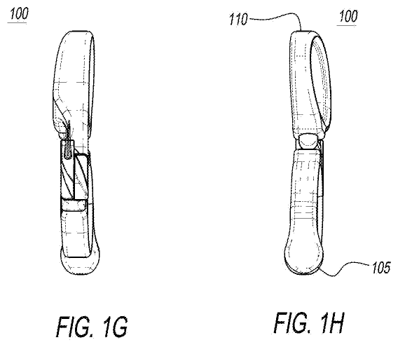

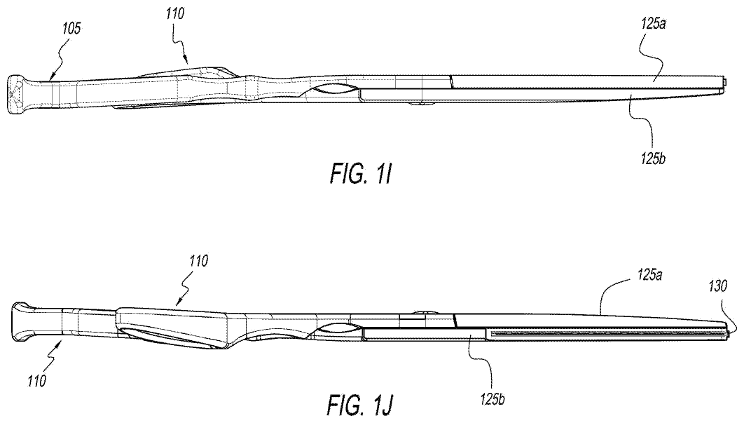

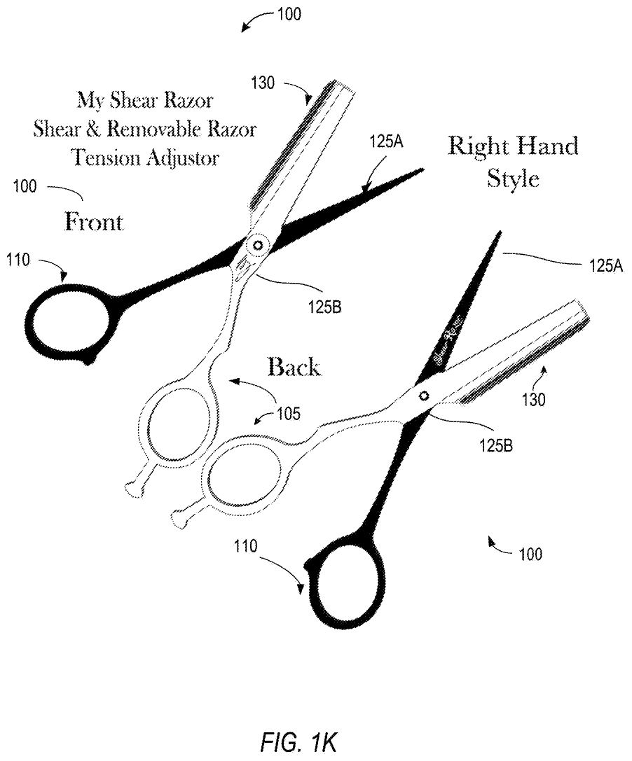

Referring now to FIGS. 1A, 1B, 1C, 1D, 1E, 1F, 1G, 1H, 11, 1J, and 1K, there are depicted several views of a first exemplary shear razor device 100. In general, the shear razor device 100 comprises a thumb member 110, the thumb member 110 comprising a grip portion affixed to a blade portion 125a, and a finger member 105, the finger member 105 also comprising a grip portion affixed to a blade portion 125b. The thumb member 110 and the finger member 105 are pivotally attached to each other for a hair shear functionality of the shear razor device 100, and the blade portion 125b of the finger member 105 comprises an elongated groove 130 configured to removably accept and secure a razor 145 therein for a razor 145 functionality of the shear razor device 100. The hair shear functionality may comprise reducing an overall length of a bundle of hair, and the razor 145 functionality may comprise reducing a length of a subset of the bundle of hair, as part of a procedure for thinning the hair. At least because the structures necessary for the hair shear functionality and the razor functionality are combined into one device, the barber or hair stylist may not need to use a plurality of devices for these tasks, thereby improving efficiency and enjoyment of hair styling.

The grip portion of the finger member 105 may comprise at least one finger ring with a finger rest affixed thereto, configured to improve an individual's grasp of the shear razor device 100 during use, and in this manner, the individual may not drop the shear razor device 100, and a risk of injury may be reduced. The razor 145 may be removably insertable into a razor cartridge 140 that is removably insertable into the elongated groove 130 to removably secure the razor 145 in the elongated groove 130 to provide the razor 145 functionality. The razor cartridge 140 may enable any of a variety of different razors to be used with the shear razor device 100 and may improve a friction fit between the elongated groove 130 and the razor 145. In this manner, the razor 145 may not slip out of the elongated groove 130 before, during, and after use of the shear razor device 100, and safety is improved.

The blade portion 125a of the thumb member 110 may terminate at a distal point, as may be the case with an ordinary pair of hair shears. However, the blade portion 125b of the finger member 105 may terminate at a distal razor cartridge insertion that is substantially flat. To assemble the shear razor device 100 and configure it for a use, the razor 145 may be removably inserted into a razor cartridge 140, which is removably inserted into the elongated groove 130, e.g., via the distal razor cartridge insertion, to removably secure the razor in the elongated groove 130. Insertion in this or similar manners may reduce a risk of injury compared to different manners of inserting the razor into the elongated groove 130.

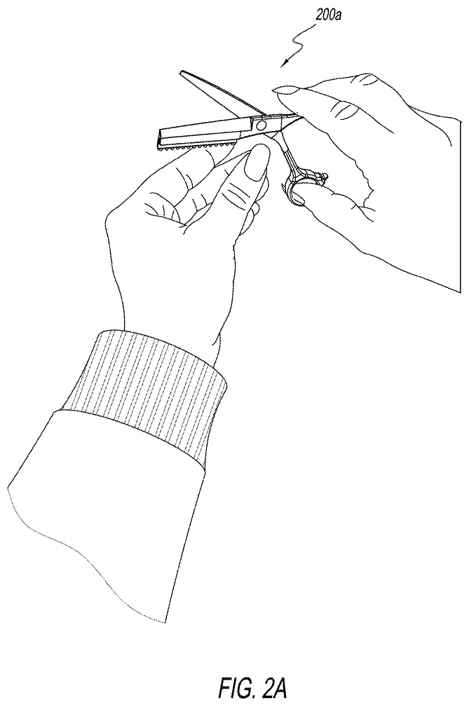

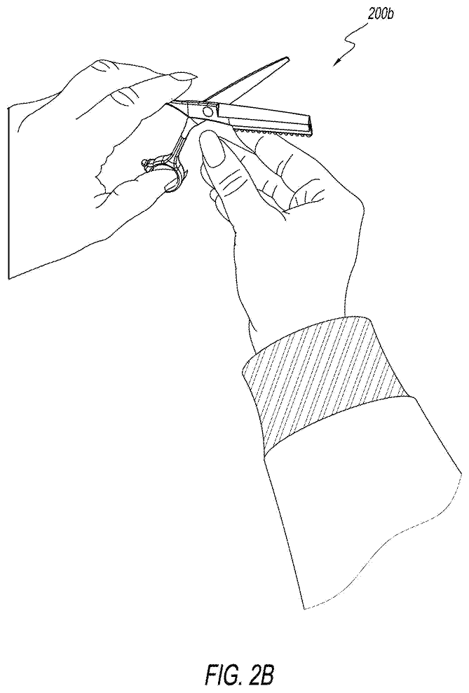

As shown in FIG. 2A, 200A and FIG. 2B, 200B The shear razor device 100 may be configured for a left-handed use 200B, a right-handed use 200B, or both, and such configurations may involve a different structure or configuration of the finger member 105 relative to the thumb member 110. For example, in certain implementations, the finger member 105 may be proximal to an individual's medial axis, and the thumb member 110 may be distal to the individual's medial axis, when the shear razor device is gripped by the individual's dominant or hair-styling hand. The elongated groove 130 may be comprised of a wider base and a narrower opening, and at least the narrower opening may provide or improve a friction fit for removably accepting and securing the razor 145 therein. In certain implementations, the friction fit may be improved with use of the razor cartridge 140. The razor cartridge 140 may comprise a plurality of ridges thereon, the plurality of ridges configured for aligning a bundle of hairs during a hair thinning procedure.

The shear razor device 100 may comprise stainless steel materials. In one or more embodiments, the shear razor device with a swivel 300 may also comprise comparable stainless steel materials as those mentioned herein. In at least one embodiment, the shear razor device 100 may comprise materials having sharp convex edge blades that comprise hardened premium steel configured to keep the sharper edge on the blades for longer. In one or more embodiments, the shear razor device 100 may also require less sharpening due the use of one or more premium hardened steel components. In one or more embodiments, the shear razor device 100 may also comprise ergonomic metals. In one or more embodiments, the shear razor device 100 may also comprise high quality steel configured to have lighter weight and improved durability. In one or more embodiments, the shear razor device 100 may further be configured such that the lighter steel may take pressure off the fingers, wrist, elbow and shoulder of the stylist while cutting. In one or more embodiments, the shear razor device 100 may further comprise high quality steels and metals that promote longer scissor life. In one or more embodiments, the shear razor device 100 may further comprise higher quality Japanese steel configured such that the scissors will be more resistant to corrosion, rust, and other general issues. For example, in one or more embodiments, the shear razor device 100 may further comprise Japanese steel shears configured to last between five, ten, or twenty years, and longer as long as the steel is well maintained. The shear razor 100 device may comprise one or more of the following: pure Japanese steel with high levels of cobalt and titanium (ATS-314), high quality Japanese steel (VG-10), high levels of Vanadium and Titanium that give extra strength to cutting knives (V-10), entry-level Vanadium and Titanium steel shears (V-1, VG-1), high Cobalt steel for razor-sharp cutting edges (S-3), Cobalt steel entry-level for hardened cutting shears (S-1), and premium hair scissors made of hardened Japanese steel (440C). The shear razor device 100 may further comprise various metals graded by edge retention, toughness, corrosion resistance, ease of sharpening, fragility or brittleness of the blade, weight, longevity, and the like. The shear razor device may comprise one or more of Maxamet, CPM-S90V, CPM-S110V, CPM-20CV, M390, CPM MagnaCut, CPM-M4, CPM CruWear, ZDP 189, CTS-204P, Elmax, CPM-10V, CPM-S30V, CPM-154, CPM-4V, AEB-L, 52100, K390, CTS-XHP, CPM-3V, CPM-S35VN, LC200N, and other steel materials. In one or more embodiments, the shear razor device 100 may comprise one or more of the following: stainless steel 50-55HRC, 55-57HRC, 57-59HRC, 58-60HRC, 60-62HRC, 61-63HRC, and other materials. In one or more embodiments, the shear razor device with a swivel 300 may also comprise comparable stainless steel materials as those mentioned herein.

Because any of a plurality of additional functionalities may be provided by different devices and structures used by barbers and hair stylists, at least one such additional functionality may, in certain implementations of the shear razor device 100, not be desired for a particular use or combination of uses. Accordingly, in implementations, the shear razor device 100 may not comprise an additional structure that is related to an additional functionality. In certain instances, the additional structure may comprise a comb and the additional functionality may comprise combing hair. In this manner, the structure and function of the shear razor device may relate primarily, or exclusively, to cutting or trimming hair, e.g., length-trimming, thinning, or both.

The razor 145 may comprise a straight razor with at least one edge thereon. Any suitable straight razor may be used, including disposable or single-use straight razors as well as at least one straight razor that may be sharpened and re-used. In certain implementations, the straight razor may be advantageous for thinning hair. During a use of the hair shear functionality, the thumb member 110 may be moved in a scissoring motion relative to the finger member 105, and during such use, the finger member 105 may be substantially stationary relative to a bundle of hair cut by the hair shear functionality.

In implementations, the elongated groove 130 may be positioned along an upper portion of the blade portion of the finger member, and a lower portion of the blade portion of the finger member may comprise an inner blade that functions as part of the hair shear functionality. The blade portion of the finger member may be comprised of a flat inner wall joined with a tapered outer wall at lower portions thereof to form the inner blade. The flat inner wall and the tapered outer wall may be disjoined at upper portions thereof to form the elongated groove 130. Accordingly, in implementations, the blade portion of the finger member may comprise the inner blade on the lower portion formed by the flat inner wall and the tapered outer wall.

Referring now to FIGS. 2A, and 2B, there are depicted several views of the first exemplary shear razor device being held by an individual. In implementations, during use, the razor may be faced downward rather than upward, to facilitate use of the razor functionality. The hair shear functionality may involve transverse or horizontal cutting of hair, and the razor functionality may involve longitudinal or vertical strokes of the razor, particularly downward vertical strokes, as may be performed when thinning hair. Because the shear razor device may be specifically configured for either left-handed use 200b or right-handed use 200a, the barber or hair stylist may be able to easily transition between the hair shear functionality and the razor functionality during use, without any need for significantly rearranging or reconfiguring the shear razor device for such transitions. In this manner, the efficiency and the safety of use may be improved.

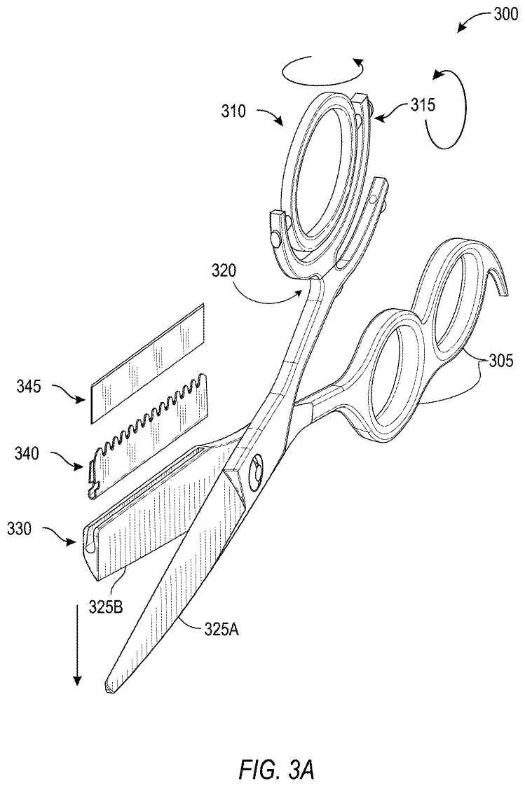

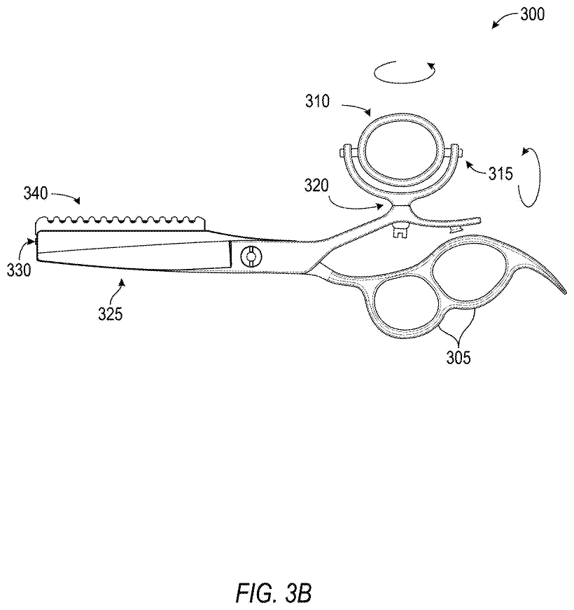

Referring now to FIGS. 3A and 3B, there are depicted additional embodiments and views of exemplary shear razor devices and accessories thereof. A cross-section of the blade portion of the finger member reveals that it may be substantially solid except for the elongated groove 330 that extends along a length of the upper portion of the blade portion of the finger member. In addition, the razor cartridge may be configured for accepting any of a variety of replacement razors therein for use, including but not necessarily limited to straight edge razors, nine gap blades, six gap blades, and any combination thereof. Such replacement razors may be provided as a pack and may be removed from the pack without needing to touch the replacement razor with the individual's hands or fingers, thereby maintaining cleanliness and safety. The thumb member and the finger member may be pivotally attached to each other at a pivot point of each member. The pivot points may be medially positioned along a length of each member and may be attached via a pivot screw.

Regarding FIG. 3A and FIG. 3B, a shear razor device with swivel 300 comprises: a thumb member 310, the thumb member 310 comprising a grip portion affixed to a blade portion 325A; a finger member 305, the finger member 305 comprising at least one grip portion affixed to a blade portion 325B; wherein the thumb member 310 and the finger member 305 are pivotally attached to each other for a hair shear functionality of the shear razor device with swivel 300, wherein the blade portion 325B of the finger member 305 comprises an elongated groove 330 configured to removably accept and secure a razor 345 therein for a razor functionality of the shear razor device with swivel 300; and wherein the thumb member 310 comprises at least one swivel joint, wherein the at least one swivel joint is configured to swivel about a horizontal axis, about a vertical axis; and wherein two swivel joints are configured to swivel about a horizontal axis and a vertical axis respectively.

Regarding FIG. 3A and FIG. 3B, in one instance, the shear razor device with swivel 300 further comprises wherein the finger member 305 comprises at least two grip portions. In one instance, the shear razor device with swivel 300 further comprises a swivel joint 315 of the thumb member is configured as at least one of a single swivel about one horizontal axis. In one instance, the shear razor device with swivel 300 further comprises a swivel joint 320 of the thumb member is configured as at least one of a single swivel about one vertical axis. In one instance, the shear razor device with swivel 300 further comprises a first swivel joint 315 of the thumb member is configured as at least one of a single swivel about one horizontal axis and a second swivel 320 about vertical axis. In all instances, the shear razor device with swivel 300 may be configured for a left-handed use, a right-handed use, or both.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

The following is claimed:

1. A shear razor device, comprising:
a thumb member, the thumb member comprising a grip portion affixed to a blade portion,
a finger member, the finger member comprising a grip portion affixed to a blade portion,
wherein the thumb member and the finger member are pivotally attached to each other for a hair shear functionality of the shear razor device,
wherein the blade portion of the finger member comprises an elongated groove configured to removably accept and secure a razor therein for a razor functionality of the shear razor device.

2. The shear razor device of claim 1, wherein the grip portion of the finger member comprises a finger ring with a finger rest affixed thereto.

3. The shear razor device of claim 1, wherein the razor is removably insertable into a razor cartridge, wherein the razor cartridge is removably insertable into the elongated groove to removably secure the razor in the elongated groove for the razor functionality.

4. The shear razor device of claim 1, wherein the blade portion of the thumb member terminates at a distal point.

5. The shear razor device of claim 1, wherein the shear razor device is configured for a left-handed use, a right-handed use, or both.

6. The shear razor device of claim 1, wherein the elongated groove is comprised of a wider base and a narrower opening, wherein at least the narrower opening removably accepts and secures the razor therein via a friction fit.

7. The shear razor device of claim 1, wherein the shear razor device does not comprise an additional structure that is related to an additional functionality.

8. The shear razor device of claim 7, wherein the additional structure comprises a comb and the additional functionality comprises combing hair.

9. The shear razor device of claim 1, wherein the razor comprises a straight razor with at least one edge thereon.

10. The shear razor device of claim 9, wherein the razor functionality comprises thinning hair.

11. The shear razor device of claim 1, wherein the blade portion of the finger member terminates at a distal razor cartridge insertion, wherein the distal razor cartridge insertion is substantially flat.

12. The shear razor device of claim 11, wherein the razor is removably insertable into a razor cartridge, wherein the razor cartridge is removably insertable into the elongated groove via the distal razor cartridge insertion to removably secure the razor in the elongated groove for the razor functionality.

13. The shear razor device of claim 1, wherein during a use of the hair shear functionality, the thumb member moves in a scissoring motion relative to the finger member.

14. The shear razor device of claim 13, wherein during the scissoring motion, the finger member is substantially stationary relative to a bundle of hair cut by the hair shear functionality.

15. The shear razor device of claim 1, wherein the elongated groove is positioned along an upper portion of the blade portion of the finger member, wherein a lower portion of the blade portion of the finger member comprises an inner blade that functions as part of the hair shear functionality.

16. The shear razor device of claim 15 wherein the blade portion of the finger member is comprised of a flat inner wall joined with a tapered outer wall at lower portions thereof to form the inner blade.

17. The shear razor device of claim 16, wherein the flat inner wall and the tapered outer wall are disjoined at upper portions thereof to form the elongated groove.

18. The shear razor device of claim 1, further comprising:
wherein the finger member comprises at least one additional grip portion affixed to the blade portion,
wherein the thumb member comprises at least one swivel joint wherein the at least one swivel joint is configured to swivel about at least one of a horizontal axis and a vertical axis.

19. A shear razor device, comprising:
a thumb member, the thumb member comprising a grip portion affixed to a blade portion,
a finger member, the finger member comprising at least one grip portion affixed to a blade portion,
wherein the thumb member and the finger member are pivotally attached to each other for a hair shear functionality of the shear razor device,
wherein the blade portion of the thumb member comprises an elongated groove configured to removably accept and secure a razor therein for a razor functionality of the shear razor device; and
wherein the thumb member comprises a swivel joint.

20. The shear razor device of claim 19, wherein the swivel joint of the thumb member is configured as at least one of a single swivel about one axis and a double swivel about two axes.
